(19) United States
(12) Patent Application Publication
(10) Pub. No.: US 2012/0326103 A1
(43) Pub. Date: Dec. 27, 2012

(54) FUNCTIONALIZED TRIPLET EMITTERS FOR ELECTRO-LUMINESCENT DEVICES

(76) Inventors: Shuk Kwan Mak, Hong Kong (CN); Wai Kin Chan, Hong Kong (CN); Tobias Fischer, Rinnbach (DE); Hartmut Yersin, Sinzing (DE)

(21) Appl. No.: 13/512,111

(22) PCT Filed: Nov. 26, 2010
(86) PCT No.: PCT/EP10/68317

§ 371 Date: Sep. 11, 2012

(30) Foreign Application Priority Data
Nov. 27, 2009 (US) 61/264731
Dec. 4, 2009 (US) 61266576

(51) Int. Cl. C07F 15/00; F21V 9/00; C09K 11/06

(52) U.S. Cl. 252/582; 546/4; 252/301.16

(57) ABSTRACT

Organo-metallic complexes for opto-electronic and sensory devices and their use in such devices are provided. The organo-metallic complex (triplet emitter) consists of a metal center and chelate ligands. At least one of chelate ligands comprises an aromatic or fused aromatic ring(s). Each ligand is covalently substituted with at least one, preferably two charge transport groups (ctg). The metal center can be coordinated by a spectator ligand. Presence of two ctgs at each ligand is advantageous for applications in organic light emitting diodes (OLEDs). Charge transport units facilitate hole and/or electron transport to the molecular center and allow for efficient exciton formation directly on the complex. Presence of ctgs on each ligand provides good shielding with respect to interactions with the environment. Emission quenching is strongly reduced and materials with high emission quantum yields are obtained. Presence of ctgs on each ligand reduces undesired quenching by triplet-triplet annihilation or self-quenching effects.

### BACKGROUND

Highly efficient electroluminescent devices, applying small molecules, especially heavy metal containing complexes, have been extensively investigated since the discovery of electroluminescence from organic materials [Tang et al. Appl. Phys. Lett. 1987, 51, 913]. Remarkable progress has been made in organic opto-electronics based on heavy metal-containing materials. Efficient OLEDs are difficult to achieve with purely organic materials because only 25% quantum efficiency (according to spin statistics) can be obtained due to the spin selection rule. However, the majority of excitons formed in an OLED are triplet excitons (75%), which in purely organic emitters will be dissipated as heat. The electro-luminescence (EL) quantum efficiency is severely limited as a consequence. Therefore, in the past decade, research in OLED materials has been focused on the development of materials that emit light from the triplet excited state [for example, see: H. Yersin, Highly Efficient OLEDs with Phosphorescent Materials, Wiley-VCH, Weinheim 2008]. By utilizing such triplet emitters, i.e. phosphorescent molecules, the (internal) electro-luminescence efficiency can exceed the theoretical limit of 25% imposed on the singlet emitters. Near unity quantum efficiency can be envisaged from harvesting both singlet and triplet excitons by using phosphorescent materials. [M. A. Baldo, D. F. O'Brien, M. E. Thompson, S. R. Forrest; Phys. Rev. B 1999, 60, 14422; C. Adachi, M. A. Baldo, M. E. Thompson, S. R. Forrest; J. Appl. Phys. 2001, 90, 5048; H. Yersin, Top. Curr. Chem. 2004, 241, 1] For example, OLEDs with green emitting iridium(III)tris(2-phenylpyridinato-N,C) [Ir(ppy)₃] in the emissive layer generate nearly 100% internal quantum efficiency by utilizing all singlet and triplet excitons [Baldo et al. Appl. Phys. Lett. 1999, 75, 4].

Different types of ligands have been used to vary the HOMO/LUMO energies and the lowest excited states to fine-tune the photophysical properties, and to improve the charge transport properties and stability of the materials. The device efficiency, lifetime, and turn-on voltage, for example, can be optimized considerably with suitable metal/ligand combinations. Injection and transport of holes and electrons from the corresponding electrodes to the emissive layer can be facilitated by appropriate charge transport layers. Charge recombination at the emitters is advantageous and would be enhanced if the ligands chelated to the metal ion are bound to charge transport units.

To process the small phosphorescent molecules into thin film devices such as OLEDs involves expensive and sophisticated techniques, if vacuum thermal evaporation at high temperature and organic vapor phase deposition (OVPD) techniques are applied. The production costs of thin film devices produced with these techniques are not competitive to the current display technology like LCD technology or to current lighting techniques. Moreover, the area of the display or the lighting surface is limited. Therefore, high interest lies in development of solution-processable phosphorescent materials in the scope for low-cost manufacturing, large area displays/lighting and printing of devices. The materials described in the present invention are solution-processable.

Dilution (low concentration doping) of triplet emitter materials into polymer-matrix host materials to avoid self-quenching or triplet-triplet annihilation is usually applied. However, these systems suffer from aggregation, phase separation, etc., which lead to luminescence quenching and reduction of device efficiencies.

Accordingly, it is an object of the present invention to address this need by providing a highly emissive material bearing covalently-bound charge transport moieties for the use in an opto-electronic device. Moreover, the substituted moieties will fulfill the requirements of shielding and thus will strongly reduce triplet-triplet annihilation, self-quenching, and aggregation or phase separation effects.

Host-free solution-processable phosphorescent materials, i.e. materials without additional matrix material, are known in the state of the art. Triplet emitters are covalently attached either as a pendant or along the conjugated backbone [WO2003/091355 A3; N. R. Evans, L. S. Devi, C. S. K. Mak, S. E. Watkins, S. I. Pascu, A. Köhler, R. H. Friend, C. K. Williams, A. B. Holmes, J. Am. Chem. Soc. 2006, 128, 6647; A. J. Sandee, C. K. Williams, N. R. Evans, J. E. Davies, C. E. Boothby, A. Köhler, R. H. Friend, A. B. Holmes, J. Am. Chem. Soc. 2004, 126, 7041]. However, polymeric materials are not mono-disperse and it is unavoidable that defect sites are generated during synthesis. These defects along the polymer chain will have adverse effects on the material stability and device performance.

In this regard, it is a further object of the invention to provide well-defined and controlled synthesis for new solution-processable emissive materials (being used as doped material or 100% pure material).

In view of the above, there still remains a need to provide methods of making well-defined, synthetically controllable, conjugated and solution-processable materials for OLEDs with good efficiency and stability. A further object of this invention is thus to provide highly emissive materials. This becomes possible due to the shielding of the outer sphere of the complex.

### SUMMARY OF THE INVENTION

The invention provides a novel type of highly substituted phosphorescent complexes that can be used as light emitters. The structure and size of the emitters are well-defined, mono-dispersed and synthetically controllable. The material can be the alternative of metal-containing polymers, which usually suffer from structural defects.

The invention relates to a complex M(ligI(ctg1)(ctg2))ₘ(ligII(ctg3)(ctg4))ₙ(ligIII(ctg5)(ctg6))ₒ(spectator)ₚ(L), that is capable of luminescence (phosphorescence or electroluminescence). The complex of the invention comprises a metal ion M and at least one ligand lig that may be substituted with charge transfer groups (ctg).

The complex of the invention can be represented by formula I:

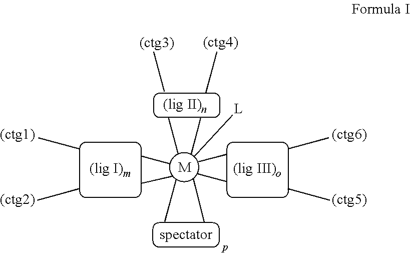

The symbols used in formula I have the following meanings:

The complex of the present invention comprises at least two ligands lig (lig I, lig II, lig III) chelating a central metal ion M. At least one of these ligands lig consists of or comprises an aromatic or fused ring. This ligand is covalently substituted with at least one charge transport groups (ctg). Preferably, the complex is neutral.

M is any metal ion, particularly a heavy metal or a lanthanide, preferably a d-block element. The metal ion M of the complex (substituted emitter) of this invention can be a transition metal or a lanthanide. The transition metal preferably is an ion of a heavy metal, more preferably iridium, platinum, gold, rhodium, ruthenium, osmium and rhenium; a lanthanide metal ion is preferably cerium, europium, terbium, samarium, thulium, erbium, dysprosium, and neodymium. Most preferably, the metal ion M is platinum or iridium.

lig (lig I, lig II, and lig III) is a chelate ligand with a conjugated π-electronic system bound to the metal ion M, comprising preferably at least two aromatic rings that can be the same or different, preferably covalently-linked to each other or fused together.

ctg is an organic charge transporting group for transporting charges (holes or electrons) and for improving the solubility of the complex in an organic solvent, such as dichloromethane, chloroform, toluene, and tetrahydrofuran. The ctgs that are part of a complex of the invention can all be the same or different, even at the same ligand, and represent a conjugated hole or electron transporting group. The ctg preferably comprises aryl or heteroaryl, preferably comprising a nitrogen atom, an oxygen atom, a sulfur atom, and/or a phosphorous atom. Nitrogen and oxygen are most preferred.

n, m, o, p are integers that can each be from 0 to 4, wherein the sum of n, m, o, p is
2 for a metal ion M with 4 coordination sites,
3 for a metal ion M with 6 coordination sites, and
4 for a lanthanide metal ion M with 8 or 9 coordination sites. If, e.g., the metal ion M is platinum, then the sum of n, m, o, p is 2 (for example, n=m=1, o=p=0). If the metal ion M is iridium, the sum of n, m, o, p is 3 (for example, n=m=o=1, p=0).

The combination of a ligand lig with 2 ctgs (lig(ctgi)(ctgj)) chelating to the metal ion M can be the same or different in a complex of the invention.

L is an optional neutral mono-dentate ligand, which may be present in a complex with M being a lanthanide metal ion. For example, the neutral mono-dentate ligand L has a lone pair of electrons, which can coordinate to the metal center via a dative bond. The neutral mono-dentate ligand can be e.g. an amine, imine, a p-substituted pyridine, an ether, isocyanate, isonitrile, nitrile, carbonyl, N-heterocycles, etc. forming a 9-site coordination complex.

spectator is a negatively charged bi-dentate (chelate) ligand and can also be referred to as an ancillary ligand. Preferably, it is chosen from the group consisting of β-diketonate, nacnac, N-alkylsalicylimine, 2-picolinate, bidentate pyrazolyl-borate, 1,2-nido-carboranediphosphines, 1,2-nido-carboranediisocyanides, 1,2-nido-carboranediarsenates, singly negatively charged diamines, singly negatively charged diphosphines, singly negatively charged diarsines, singly negatively charged bis-guanidine, bidentate negatively charged thiolates, bidentate negatively charged alcoholates, bidentate negatively charged phenolates, etc. In a photophysical sense, the frontier orbitals of the spectator or ancillary ligand are not directly involved in the electronic structure of the emitting triplet state of the complex of the invention.

In a preferred embodiment, the aryl or heteroaryl group of the ctg comprises a chemical group selected from the group consisting of: phenyl, biphenyl, phenol, pyridine, pyrimidine, pyrazine, triazine, pyrrole, pyrazole, imidiazole, triazole, thiophene, furan, thiazole, oxazole, oxadiazole, thiadiazole, naphthalene, phenanthrene, fluorene, carbazole, benzothiophene, benzimidazole, benzothiazole, and benzoxazole.

Further, it is preferred that the ctgs comprise a nitrogen, an oxygen, a sulfur, and/or a phosphorous atom, as these type of atoms enhance the charge transfer abilities of the complex of the invention.

Preferably, the ctg for transporting a hole comprises a chemical group that is covalently bound to the ligand lig and is selected from the group consisting of: substituted or unsubstituted diarylamine, substituted or unsubstituted triarylamine, substituted or unsubstituted carbazole, substituted or unsubstituted thiophene, substituted or unsubstituted pyrrole, substituted or unsubstituted 3,4-ethylenedioxythiophene, substituted or unsubstituted fused thienothiophene, substituted or unsubstituted oligothiophene, substituted or unsubstituted tris(oligoarylenyl)amine, substituted or unsubstituted spiro compound, substituted or unsubstituted benzidine compound.

Preferred ctgs for transporting a hole are shown in FIG. 2.

Preferably, the ctg for transporting an electron comprises a chemical group that is covalently bound to the ligand lig and is selected from the group consisting of: substituted or unsubstituted oxadiazole, substituted or unsubstituted thiadiazole, substituted or unsubstituted triazole, substituted or unsubstituted pyridine, fluoroaryl, fluoroheteroaryl, substituted or unsubstituted benzimidazole, substituted or unsubstituted perylene and perylene derivatives, substituted or unsubstituted tris(phenylquinoxaline), substituted or unsubstituted silole compounds, substituted or unsubstituted boron containing compounds.

Preferred ctgs for transporting an electron are shown in FIG. 3.

In one preferred embodiment of the present invention, the complex contains both at least one ctg, which acts as a hole transporting group, and one ctg, which acts as an electron transporting group. Such a complex represents a bipolar compound. The use of such a bipolar compound can simplify the fabrication of OLEDs a great deal and therefore reduces production costs of OLEDs.

Although the substitution of the ligands lig with preferably two ctgs results in complexes that are well-soluble in organic solvents, the substitution of the ctgs with solubilizing groups may further improve the solubility of the complex of the invention. Preferred solubilizing groups include alkyl, alkoxy and polyether groups. It is preferred that the complex can be processed in a solution of at least one organic solvent, e.g. for producing an opto-electronic device, such as an OLED.

It is preferred that the complex of the invention is a complex of formula II:

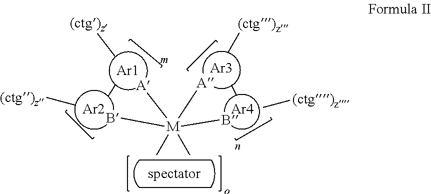

In this preferred embodiment of the invention, the ligand lig of formula I is further defined. Specifically, the ligand lig of formula I comprises two aromatic rings Ar (Ar1 and Ar2 as well as Ar3 and Ar4).

In particular, Ar1, Ar2, Ar3 and Ar4 are the same or different aromatic rings, preferably covalently-linked or fused together and represent five or six-membered aryl or heteroaryl or fused aryl or fused heteroaryl, wherein every Ar1, Ar2, Ar3, and Ar4 can comprise of two or three or four covalently linked or fused aromatic rings, and wherein the different ligands can also be linked by bridging groups, such as aryl and substituted aryl, amine, ether, oligo-ether, vinyl, alkene groups, aliphatic groups, spiro groups, silyl groups, borane groups, phosphane and arsane groups, silane groups etc.

In one preferred embodiment of the invention, the spectator shown in formula II is absent (o=0) in the complex. In this case, one ligand consists of or comprises two aromatic rings, Ar1 and Ar2, a second ligand consists of or comprises two aromatic rings, Ar3 and Ar4, and a third ligand consists of or comprises two aromatic rings, Ar5 and Ar6. Ar5 then comprises A′″ and Ar6 comprises B′″, as will be understood by a person of skill in the art. Ar1, Ar2, Ar3, Ar4, Ar5, and Ar6 can be the same or different aromatic rings, preferably covalently-linked or fused together and represent five or six-membered aryl or heteroaryl or fused aryl or fused heteroaryl, wherein Ar1, Ar2, Ar3, Ar4, Ar5, and Ar6 each can comprise or consist of two or three or four covalently linked or fused aromatic rings, and wherein ligands can also be linked by bridging groups, such as aryl and substituted aryl, amine, ether, or oligo-ether, vinyl, alkene groups, aliphatic groups, spiro groups, silyl groups, borane groups, phosphane and arsane groups, silane groups etc.

The other symbols used in formula II have the following meaning:
M is a metal ion as defined for formula I.
ctg′, ctg″, ctg′″, and ctg″″ are the same or different charge transporting groups and represent preferably a conjugated hole or electron transporting group comprising aryl or heteroaryl comprising nitrogen, oxygen, sulfur, and/or phosphorous atoms. ctg′, ctg″, ctg′″, and ctg″″ are being covalently substituted to Ar1, Ar2, Ar3, and Ar4, respectively. If a third ligand is present in the complex comprising Ar5 and Ar6 (i.e. if no spectator is present, o=0), then Ar5 would be bonded to a charge transporting group ctg′″″, and Ar5 would be bonded to a charge transporting group ctg″″″. Preferred ctgs are described above and herein, also with reference to formula I and in FIGS. 2 and 3.
A′ and B′ and A″ and B″ are the same or different and represent the coordination sites of an aromatic ring Ar to the metal ion M; preferred coordination sites are carbon or nitrogen. If no spectator is present (o=0) in the complex, a third ligand consisting of or comprising two aromatic rings, Ar5 and Ar6, is present. Ar5 then comprises A′″ and Ar6 comprises B′″.
z′, z″, z′″, and z″″ are the same or different and represent an integer of 1 to 4. If no spectator is present (o=0) in the complex, a third ligand consisting of or comprising two aromatic rings, Ar5 and Ar6, can be present. Ar5 then comprises A′″ and Ar6 comprises B′″. The number of ctgs bound to Ar5 and Ar6 could be between 1 and 4.
n, m, o, p is each an integer that can independently be from 0 to 4. p (not shown in formula II) represents in integer of a third ligand consisting of or comprising aromatic rings, Ar5 and Ar6 (that may be present, e.g. if o=0). The sum of n, m, o, p is 2 for a metal ion M with 4 coordination sites, 3 for an ion center M with 6 coordination sites, 4 for a metal ion M with 8 coordination sites (such as defined for formula I). In addition, a further ligand L as defined above may be required.
The combination of ligand and covalently bonded ctg chelating to the metal ion M can be the same or different for a complex of the invention.
The spectator is a negatively charged bi-dentate ligand selected from the group comprising β-diketonate, nacnac, N-alkylsalicylimine, 2-picolinate, bidentate pyrazolyl-borate, 1,2-nido-carboranediphosphines, 1,2-nido-carboranediisocyanides, 1,2-nido-carboranediarsenates, singly negatively charged diamines, singly negatively charged diphosphines, singly negatively charged diarsines, singly negatively charged bis-guanidine, bidentate negatively charged thiolates, bidentate negatively charged alcoholates, bidentate negatively charged phenolates, etc.

Particularly preferred compounds of the invention are shown in FIG. 1.

In a further aspect of the invention, a complex as described above and herein is used as a light emitter or a light absorber, in particular in an opto-electronic element. A complex of the invention can be used together with at least one other material, in particular with at least one other matrix material at a complex concentration of 5 weight % to 30 weight %. It is particularly preferred to use a complex of the invention for high brightness applications (>500 lm/W) with small roll-off tendency. The roll-off tendency is preferably smaller than 20% compared to an efficiency obtained in the 100 lm/W range. The term “roll-off” describes the efficiency decrease of an OLED with increasing current density (as described in J. Kido et al., Jap. J. Appl. Phys. 2007, 46, L10).

It is preferred that the opto-electronic element that the complex of the invention is used for is chosen from the group consisting of: organic light-emitting diodes (OLEDs), light-emitting electrochemical cells, organic diode, organic photodiode, OLED-sensors (in particular in gas and vapor sensors that are not hermetically sealed), organic solar cells, organic field effect transistors, organic lasers, and down-conversion systems, i.e. an opto-electronic element that transforms UV into visible light and blue light into green or red light, respectively.

A preferred use of the compounds of the invention is as a light emitter in a sensor element, e.g. for the detection of O₂. In such a case, the emission decay time of the emitter should be long, e.g. 10 μs to 100 μs. The fraction of the complex in the emission layer is preferably 5% to 100%.

In other cases, the fraction of the complex of the light emitter or the absorber is preferably in the range of 0.1% to 99%.

It is most preferred that the complex is used in an OLED device. The concentration of the complex as a light emitter in optical light emitting elements, in particular in OLEDs, is between 1% and 20%. For this purpose, the complex of the invention applied as an emitter in the OLED should exhibit an emission decay time that is as short as possible. Preferably, the emission decay time of the complex is between 0.5 μs to 10 μs.

In a preferred embodiment of the invention, the complex serves as both a charge transport material and a light emitting material.

In a further aspect, the invention pertains to an opto-electronic element comprising a complex of the invention as described above and herein.

Such an opto-electronic element can be implemented as an element chosen from the group consisting of: organic light-emitting element, organic photodiode, organic diode, organic solar cell, organic transistor, organic light-emitting diode, light-emitting electrochemical cell, organic field effect transistors, organic laser, and down-conversion systems transforming UV light into visible light and transforming blue light into green or red light.

The invention further pertains to a method for producing an opto-electronic element, which comprises a complex of the invention as described above and herein. In such a method, a complex of the invention as described above and herein can be applied onto a support or carrier. The application of the complex is preferably performed using means of wet chemistry, as the complexes described in the present invention are solution-processable.

In another aspect, the invention pertains to a method for influencing or changing the characteristics of the emission and/or absorption of an electronic element. This method comprises adding a complex of the invention as described above and herein to a matrix material for transferring electrons or holes in an opto-electronic element.

Also, the invention refers to the use of a complex of the invention as described above and herein, in particular, in an opto-electronic element, for transforming UV into visible light or blue light into green, yellow or red light, respectively. This process is also known to a person of skill in the art as down-conversion.

### Six Important Advantages of the Present Invention

In a first aspect, the present invention provides complexes as novel light emitting materials in which the metal centers are well-shielded by bulky charge transport groups on the ligands. Each aromatic ring that chelates to the metal ion is preferably substituted with at least one charge transport group (preferably two substituted groups per bidentate ligand). Thus, the interactions between adjacent complexes are largely reduced. Consequently, triplet-triplet annihilation and self-quenching can be strongly suppressed in any form of structure configuration of the emitters. Moreover, the possibility of the emitter being attacked by oxygen, moisture and other impurities is also be minimized.

In a second aspect, the charge transport groups are covalently bound to the ligand. The aromatic rings of the charge transport group provide solubility to the emitter complexes in common organic solvents and allow processing the material by wet-chemical methods.

In a third aspect, the charge transport group substituted to the ligand, that coordinates to the metal center M, are made up of aryl, heteroaryl, comprising a nitrogen, oxygen, sulfur, and/or phosphorous atom. The π-system of the substitutions assists the charge transport to the metal complex.

In a fourth aspect, different types of ligands, charge transport groups, and metal ion centers are presented in this invention. The invention provides a wide range of phosphorescent materials that are capable of fine-tuning the HOMO/LUMO gap, the triplet state energy, photophysical properties, and charge transport properties by optimizing the metal-ligand combination in the emitters for opto-electronic applications.

In a fifth aspect, the complexes of the invention can serve as both as charge transport material and as an emitter material.

In a sixth aspect, the emitter complex can contain both at least one ctg, which acts as a hole transporting unit, and one ctg, which acts as an electron transporting unit, thereby forming a bipolar complex. The use of such bipolar complexes can strongly simplify OLED fabrication costs.

### Synthesis of the Complex of the Invention

In a further aspect, the invention refers to the synthesis of a complex of the invention as described above and herein.

The combination of a metal ion M and ligands lig of the complex of formula III serves as an intermediate for the reaction with charge transport groups (ctg):

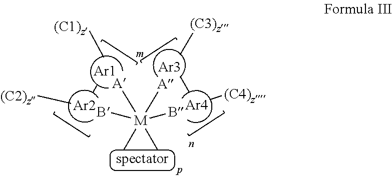

In formula III, C1 to C4 is each a reactive group (e.g. a halide, a boronic acid group, a boronic ester group, a vinyl group, an acetylenyl group, a trialkylstannane group) bound to a ligand lig consisting of aromatic groups Ar (Ar1 and Ar2; Ar3 and Ar4) for metal-catalyzed coupling reactions with charge transport groups. The other symbols in formula (III) are the same as described above for formula (II). For variations of complexes of formula III and preferred embodiments, reference is made to the description above. It will be understood by a person of skill in the art how to amend the synthesis scheme of the complex of the invention, if, for example, no spectator is present and a third ligand comprising Ar5 and Ar6 is present.

As used herein, the term ligand lig, consisting of two aromatic groups Ar (Ar1 and Ar2; Ar3 and Ar4) represents preferably two or more of the five- or six-membered aryl or heteroaryl, fused aryl, fused heteroaryl coordinates to the metal center in which these two aryl groups are conjugatively bound to eath other or fused together. The aryl within the ligand includes phenyl, biphenyl, phenol; the heteroaryl includes pyridine, pyrimidine, pyrazine, triazine, pyrrole, pyrazole, imidiazole, triazole, thiophene, furan, thiazole, oxazole, oxadiazole, thiadiazole; fused aryl includes naphthalene, phenanthrene, fluorene; fused heteroaryl includes carbazole, benzothiophene, benzimidazole, benzothiazole, and benzooxazole.

In one preferred embodiment, C1 to C4 is independently selected from the group comprising reactive halide groups, boronic acid group, boronic ester group, vinyl group, acetylenyl group, trialkylstannane group on each metal-chelating ring for the metal-catalyzed coupling reactions with charge transport groups. C1 to C4 are preferably the same; preferably, each metal-chelating ring of the ligand contains at least one of C1 to C4.

In the synthesis of a complex of the invention, “charge transport parts” are preferably used that are represented by formula (IV):

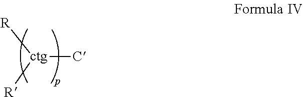

wherein:
cgt is a charge transport group, representing a hole transport group or an electron transport group (as defined above);
C′ is a reactive group that can be used for metal-catalyzed coupling reactions with a chelating ligand. It represents, for example, a halide group, boronic acid group, boronic ester group, vinyl group, acetylenyl group, trialkylstannane group on the charge transport group. Each C′ is preferably complimentary to C1 to C4 on the structure of Formula II. Each C1 to C4 and C′ can undergo a metal-catalyzed coupling reaction to form covalent carbon-carbon bonds or carbon-nitrogen bonds between the metal chelating ligand and the charge transport group.
R and R′ are the same or different, and represent hydrogen, solubilizing groups, electron donating groups or electron withdrawing groups; and
p is an integer from 1 to 10.

In a preferred embodiment, each ligand lig, comprising aryl or heteroaryl chelating to the metal ion M, should have at least two charge transport groups. In another preferred embodiment, the charge transport group on each ligand comprising aryl or heteroaryl preferably have the same charge transport nature, i.e. all of the ctgs are either hole transporting or electron transporting. In selecting ligands, account should be taken of possible steric hindrance and solution processability, which is understood by a person of skill in the art.

In one embodiment, in order to increase conjugation of the charge transport group with the ligand, it is preferred that the charge transport group comprises an aryl or heteroaryl or vinyl or acetylenyl group and/or a nitrogen atom.

Preferably, aryl or heteroaryl of the hole transport group comprise a group selected from the group consisting of substituted or unsubstituted diarylamines, substituted or unsubstituted triarylamines, substituted or unsubstituted carbazoles, substituted or unsubstituted thiophenes, substituted or unsubstituted pyrroles, substituted or unsubstituted 3,4-ethylenedioxythiophene, substituted or unsubstituted fused thienothiophene, substituted or unsubstituted oligothiophene, substituted or unsubstituted tris(oligoarylenyl)amine, substituted or unsubstituted spiro compound, substituted or unsubstituted benzidine compound.

Preferably, aryl or heteroaryl of the electron transport group comprise a group selected from the group including substituted or unsubstituted oxadiazole, substituted or unsubstituted thiadiazole, substituted or unsubstituted triazole, substituted or unsubstituted pyridine, fluoroaryl, fluoroheteroaryl, substituted or unsubstituted benzimidazole, substituted or unsubstituted perylene and perylene derivatives, substituted or unsubstituted tris(phenylquinoxaline), substituted or unsubstituted silole compound, substituted or unsubstituted boron containing compound.

Preferably, the C′ in Formula IV is selected from the group comprising secondary amine groups, reactive halide groups, boronic acid groups, boronic ester groups, vinyl groups, acetylenyl groups, trialkylstannane groups on the hole transport groups, electron transport groups or bipolar groups.

When performing the complex synthesis with different charge transport parts (each species of the charge transport parts having a different C′), each C′ is preferably complimentary to C1 to C4 on the structure of Formula III. Each and C1 to C4 and C′ can undergo a metal-catalyzed coupling reaction to form a covalent carbon-carbon bond or a carbon-nitrogen bond between the metal chelating ligand lig and the charge transport group ctg.

R and R′ of formula IV are the same or different on the hole transport group or electron transport group to enhance the solubility of the complex. The preferred solubilizing groups on the charge transport groups include branched and unbranched alkyl, branched and unbranched alkoxy, alkenyl, alkylsilane, dialkylamine, polyether groups (for example, tert-butyl, 2-ethylhexyl, tert-butoxyl, 2-ethylhexyloxy, C₁-to-C₁₂ alkyl, C₁-to-C₁₂ alkoxyl, tri-C₁-to-C₁₂ alkylsilane, tri-C₁-to-C₁₂ alkoxylsilane, di-C₁-to-C₁₂ dialkylamine). It is preferred that the complex is solution-processable.

In order to enhance and fine-tune the energy gap between HOMO and LUMO and the charge carrier mobility of the substituted emitter complex, electron donating/withdrawing groups can be substituted on the charge transport groups.

For hole transport substituents, preferably R and R′ in formula IV are the same or different. They represent electron donating groups including alkyl, alkoxyl, aryl, hydroxyl, amines, thienyl, pyrrolyl. For electron transport substituents, R and R′ are the same or different, they represent electron withdrawing groups including fluorine, cyano, nitro, fluorinated aryl, fluoroalkyl, ester, carboxyl, ketones, amides, phosphonates and sulphones, pyridyl, triazoyl.

### FIGURES

The invention is illustrated in conjunction with the figures. They show:

FIG. 1: examples of metal complexes of the invention;

FIG. 2: examples of charge transport groups (ctg) in the form of hole transport groups as substituents of the ligands (the ctgs are covalently linked via # to the ligands);

FIG. 3: examples of charge transport groups (ctg) in the form of electron transport groups as the substituents of the ligands (the ctgs are covalently linked via # to the ligands);

FIG. 4: emission and excitation spectra of Ir[(TPA)₂ppy)]₃ dissolved in PMMA (via CH₂Cl₂). The emission decay time was measured at λₘₐₓ=560 nm after excitation at λ_{exc}=372 nm; and

FIG. 5: a schematic example of an OLED-Device with an emitter layer comprising or consisting or a complex of the invention. This layer can be applied using wet chemistry. The thickness indicated for the layers serve as examples only.

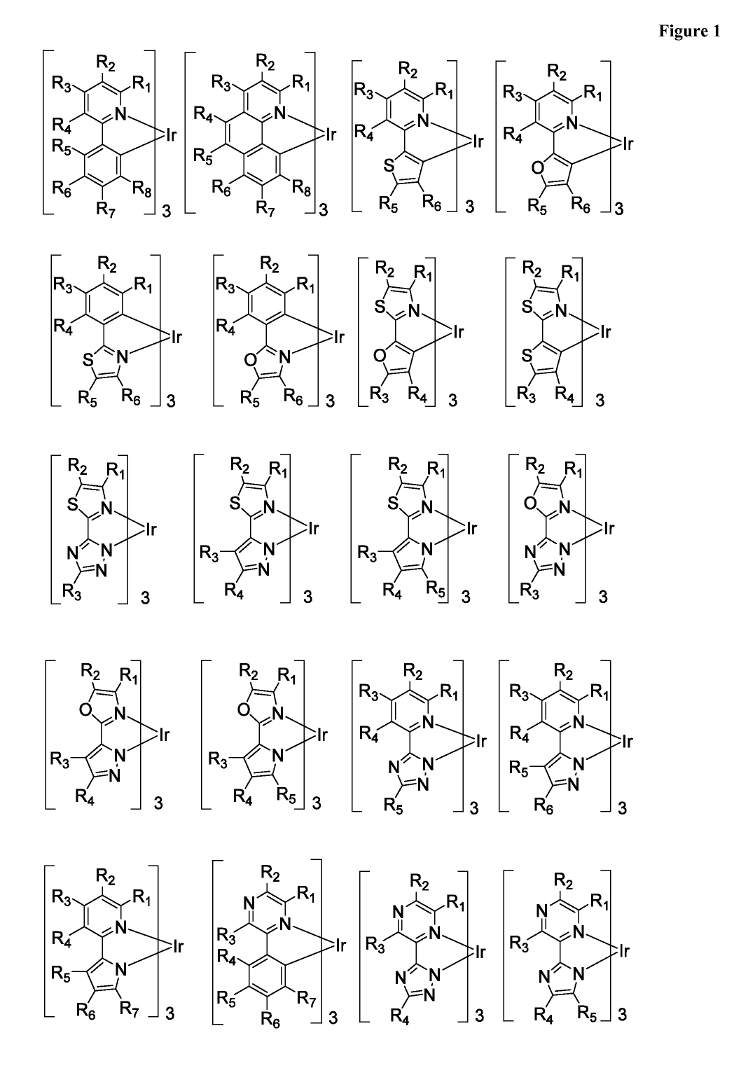

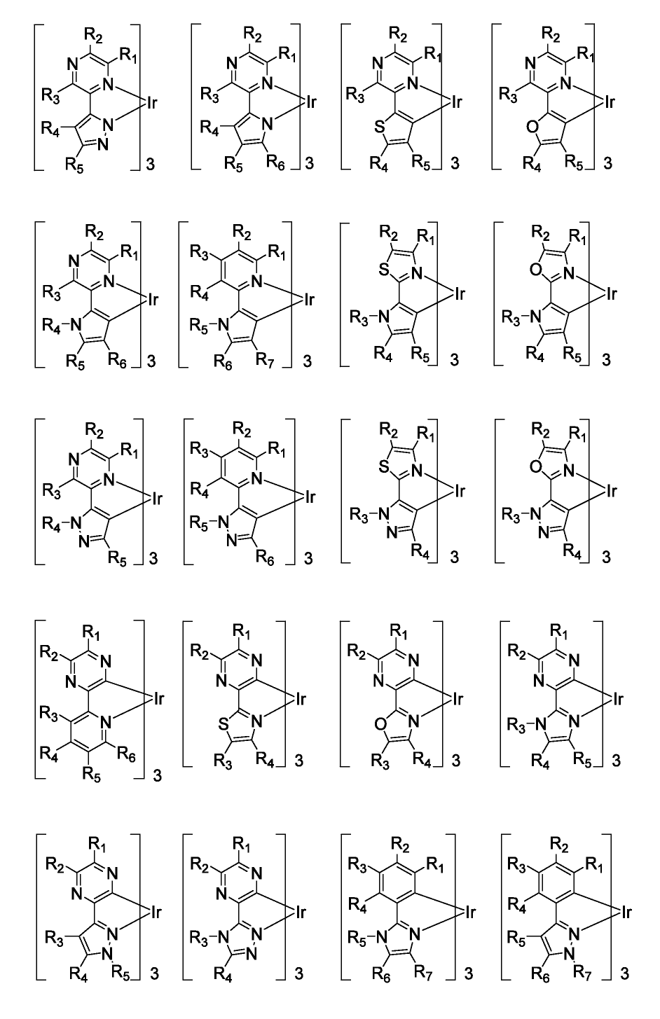

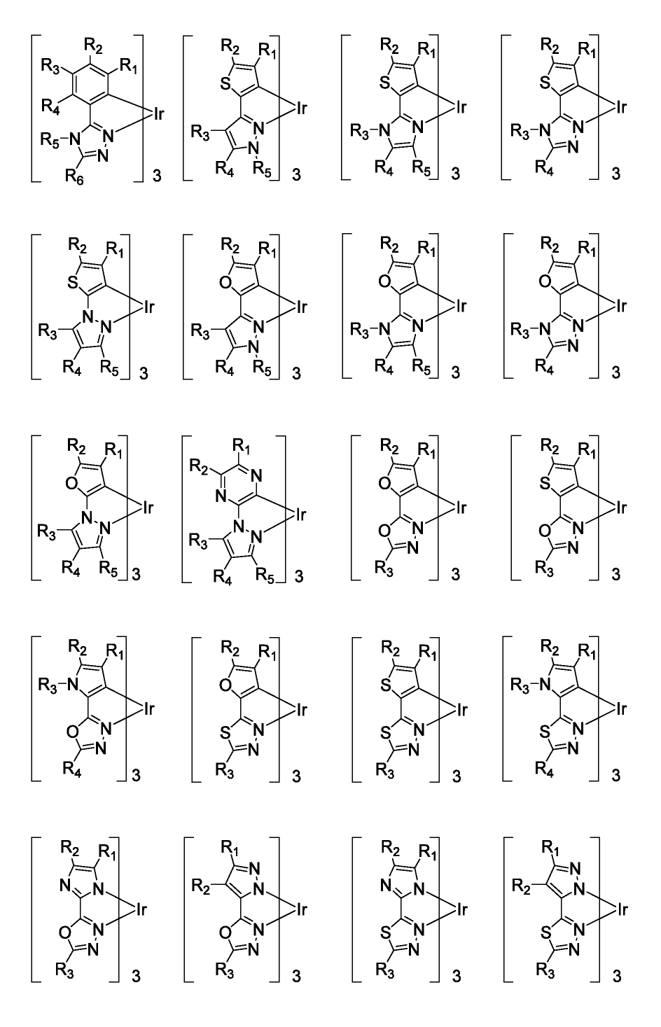

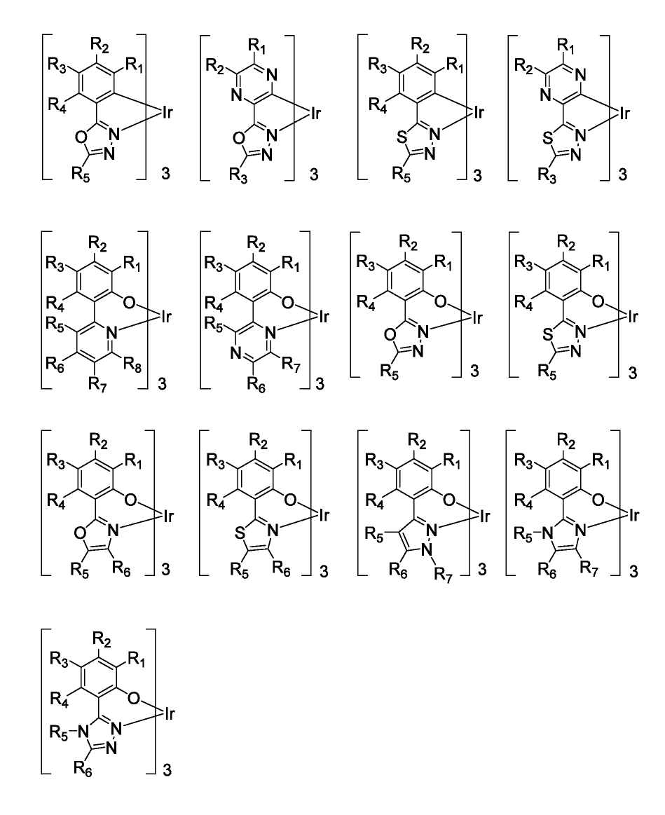

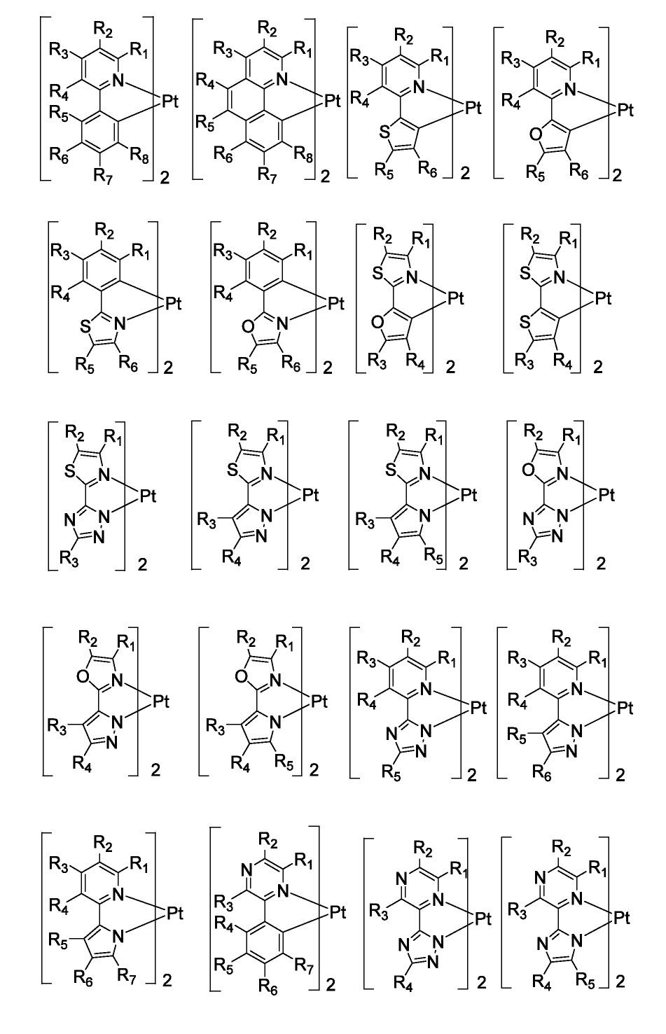

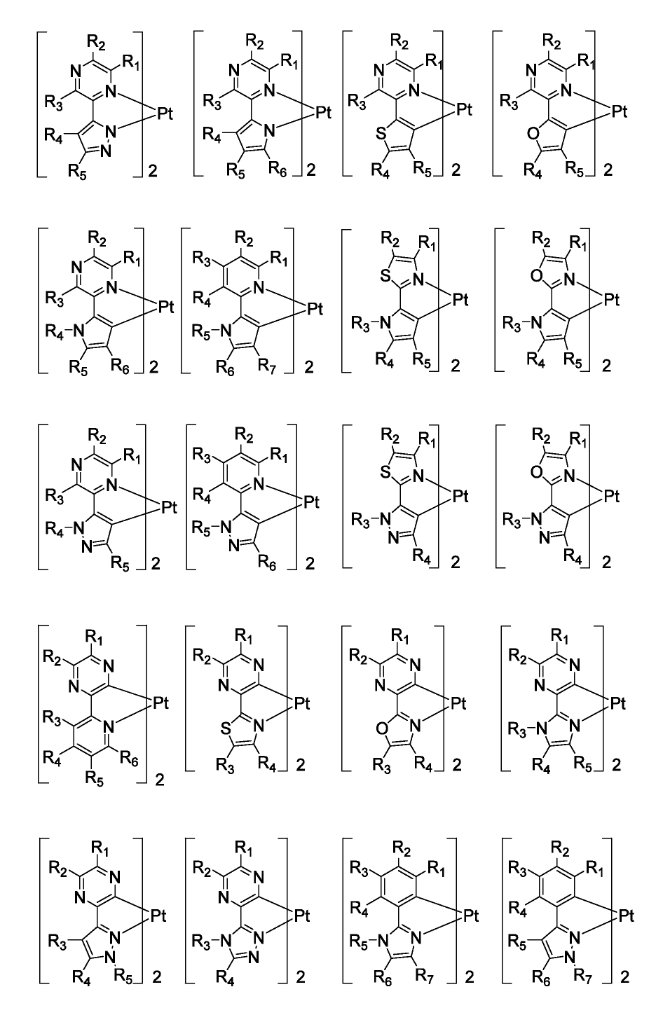

FIG. 1 shows examples of complexes of the invention (triplet emitters). R₁-R₁₀ can be the same or different and represent a charge transport group (ctg), which can also improve the solubility of the complex of invention. Preferably, each ligand lig is substituted with one or preferably with two ctgs to avoid problems of steric hindrance. Accordingly, R₁-R₁₀ may also be another substituent, e.g. —H.

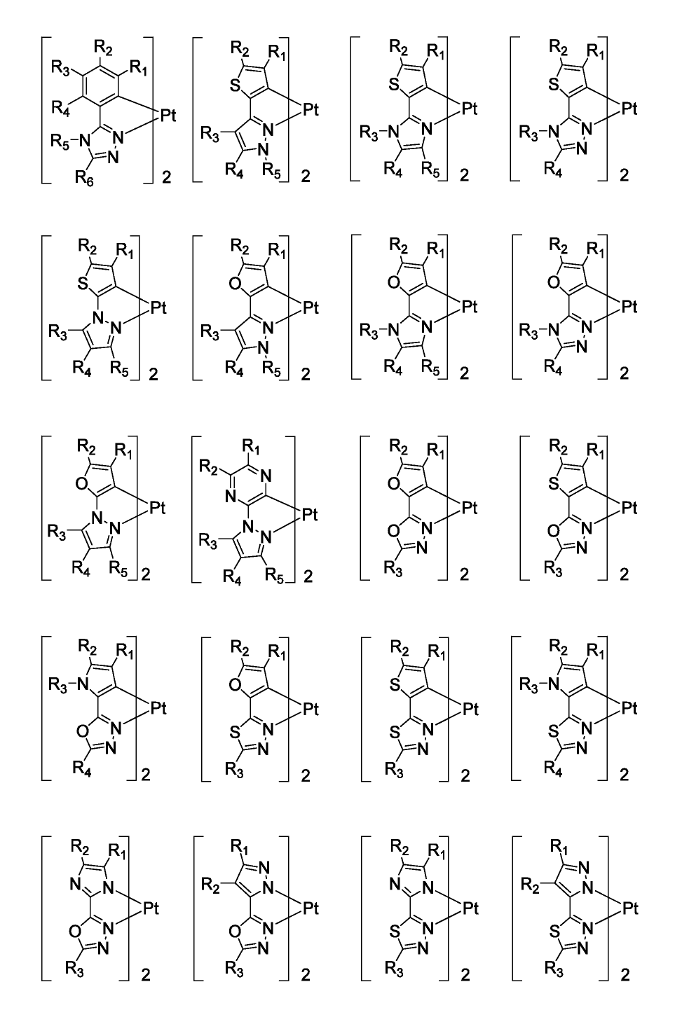

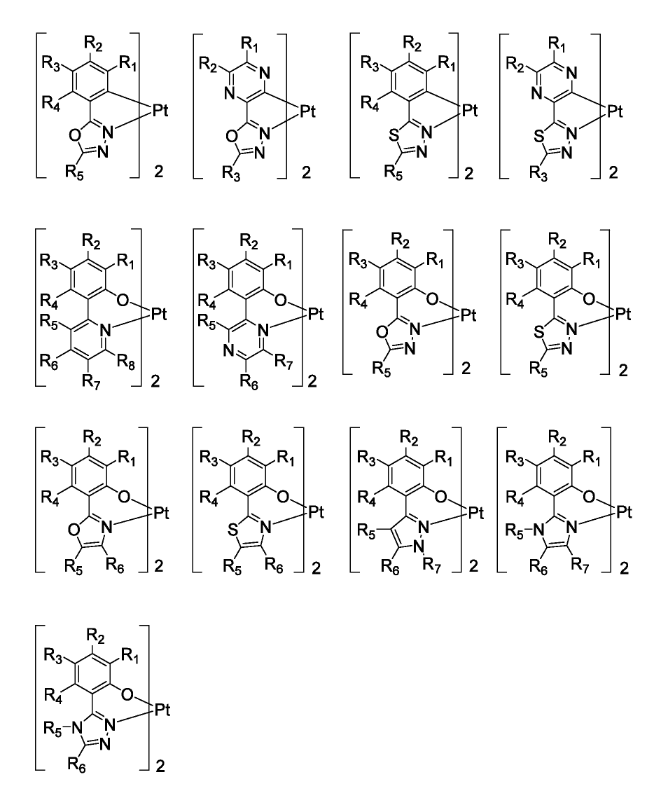

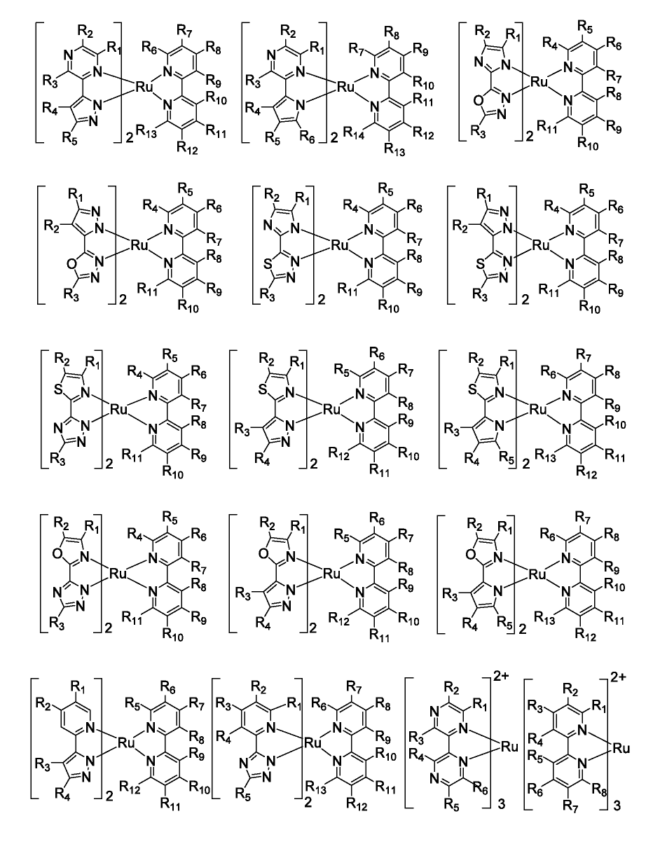

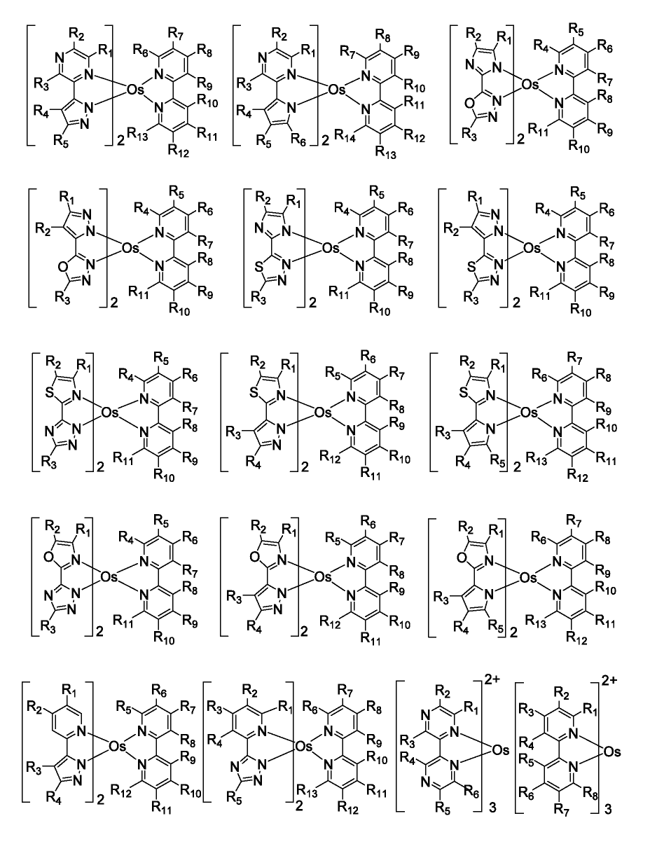

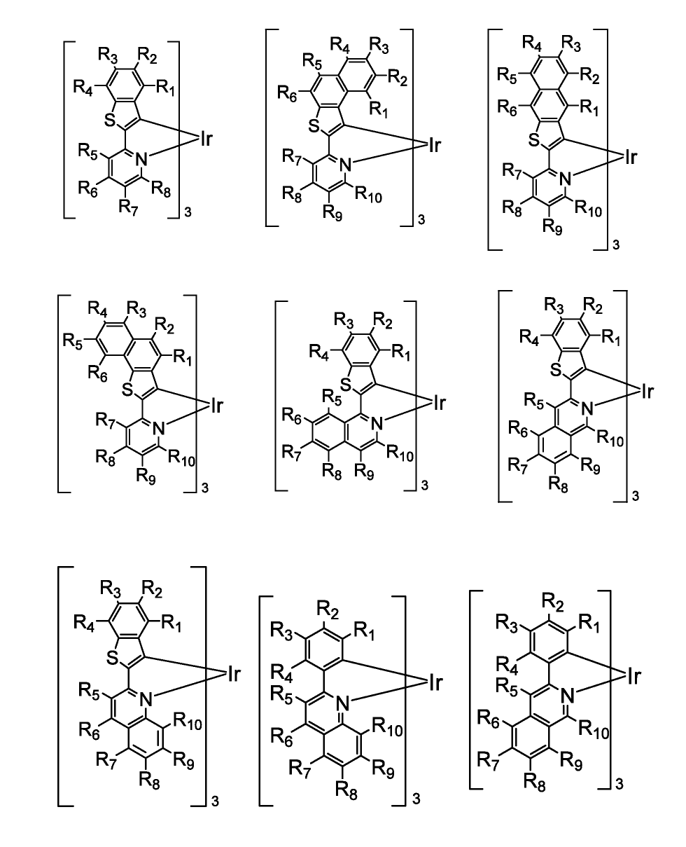

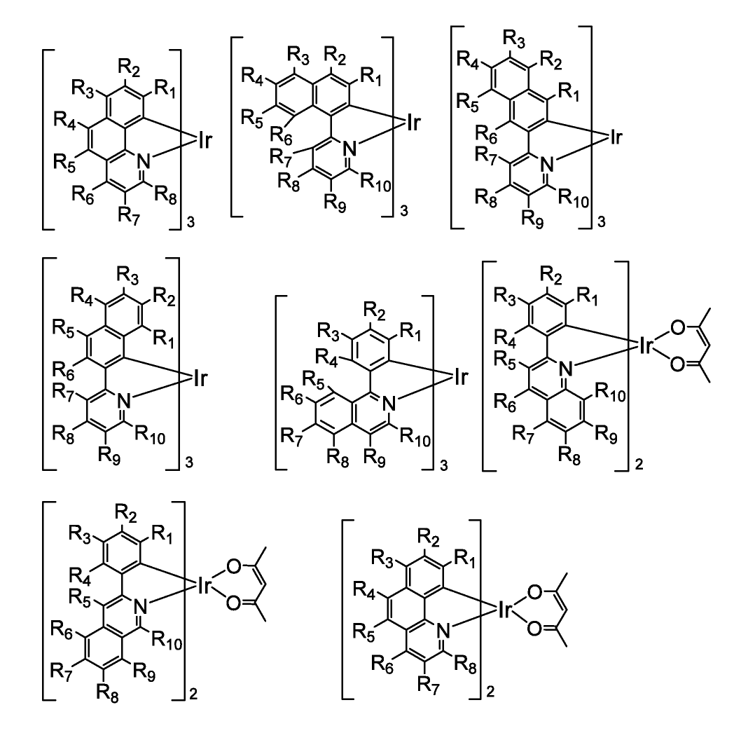

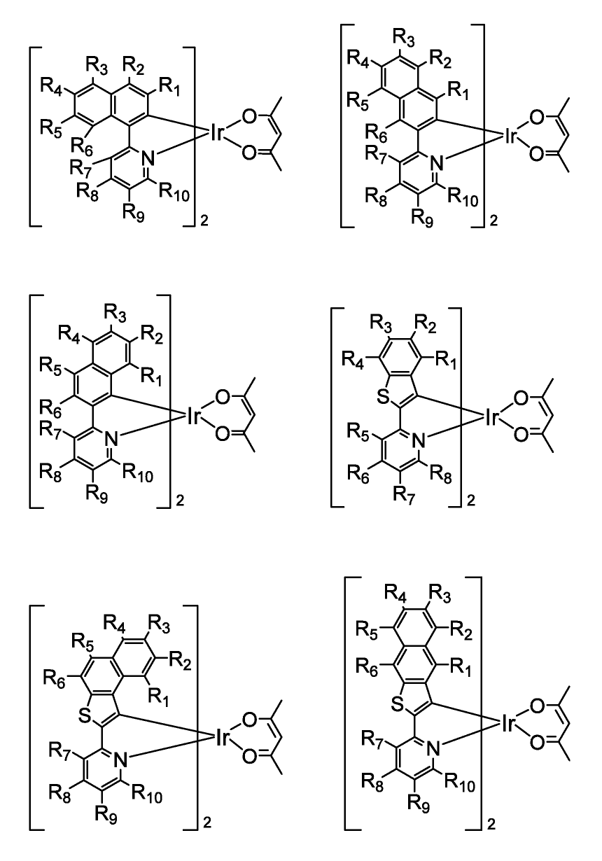

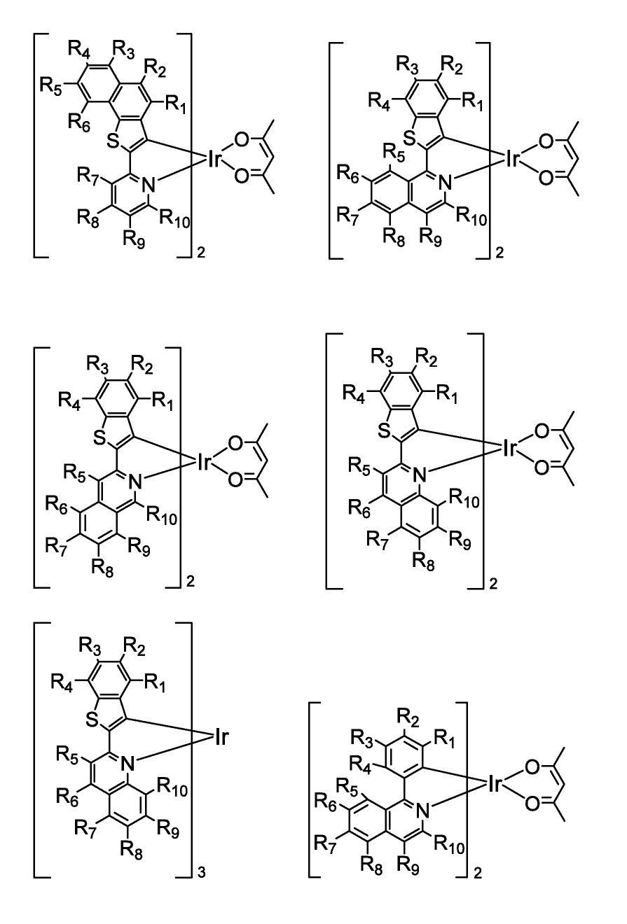

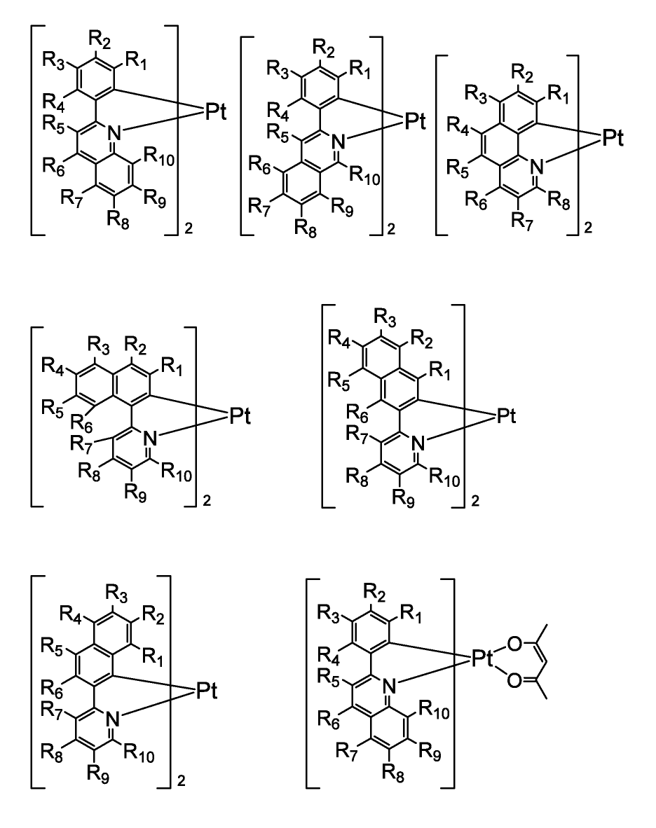

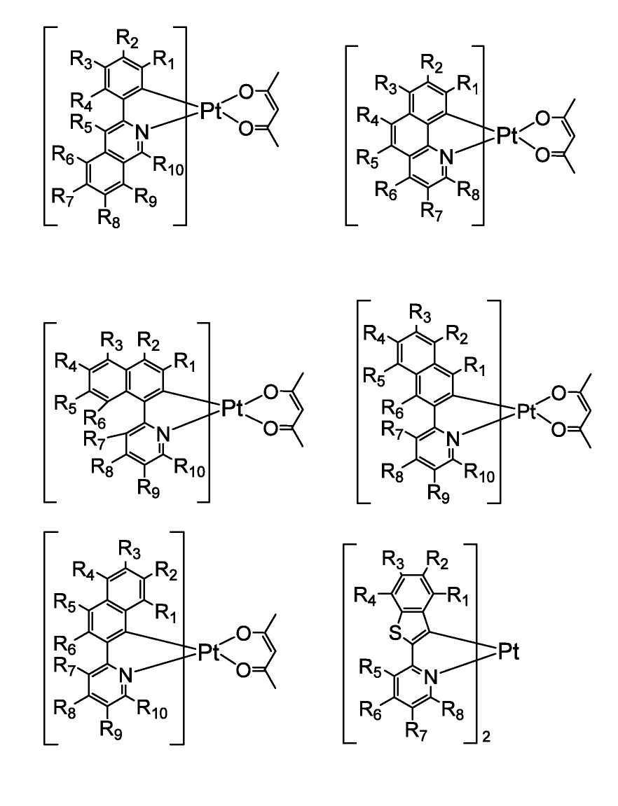

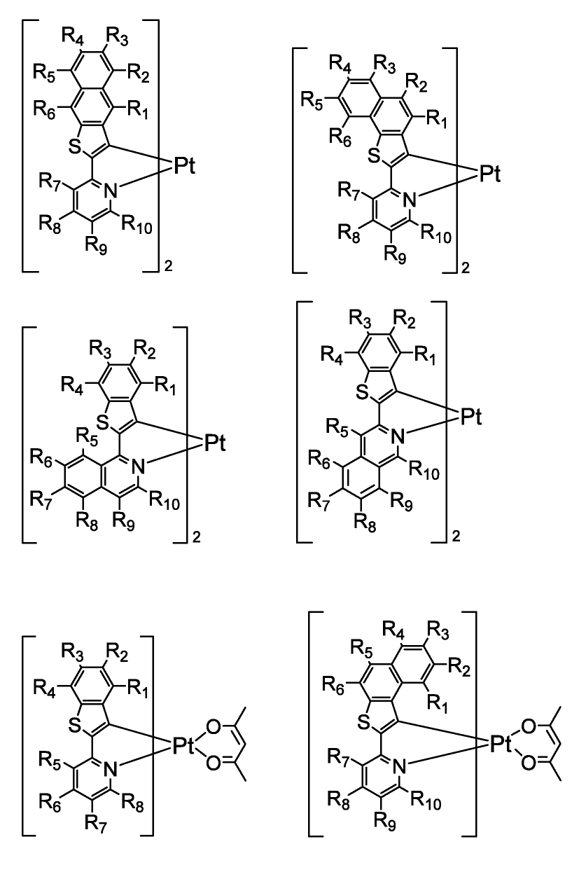

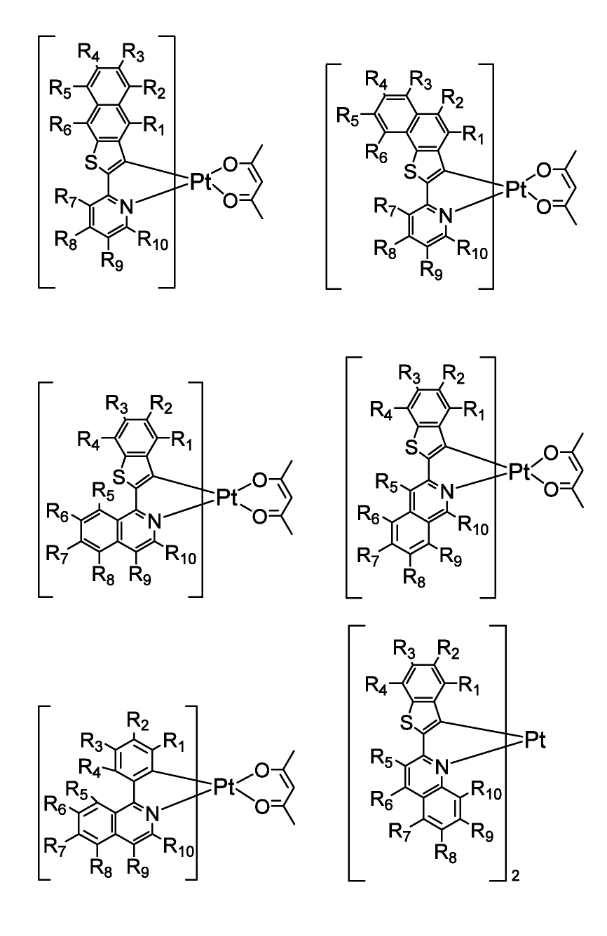

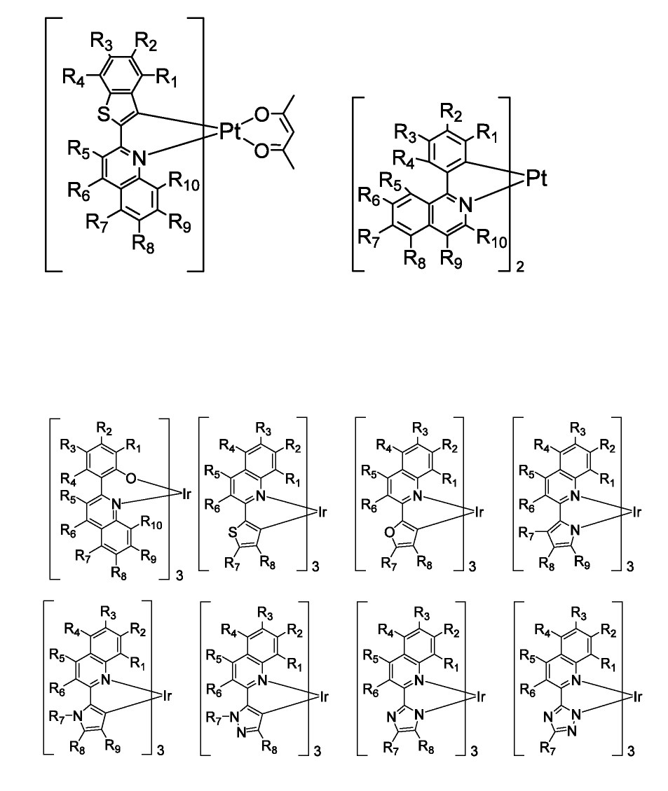

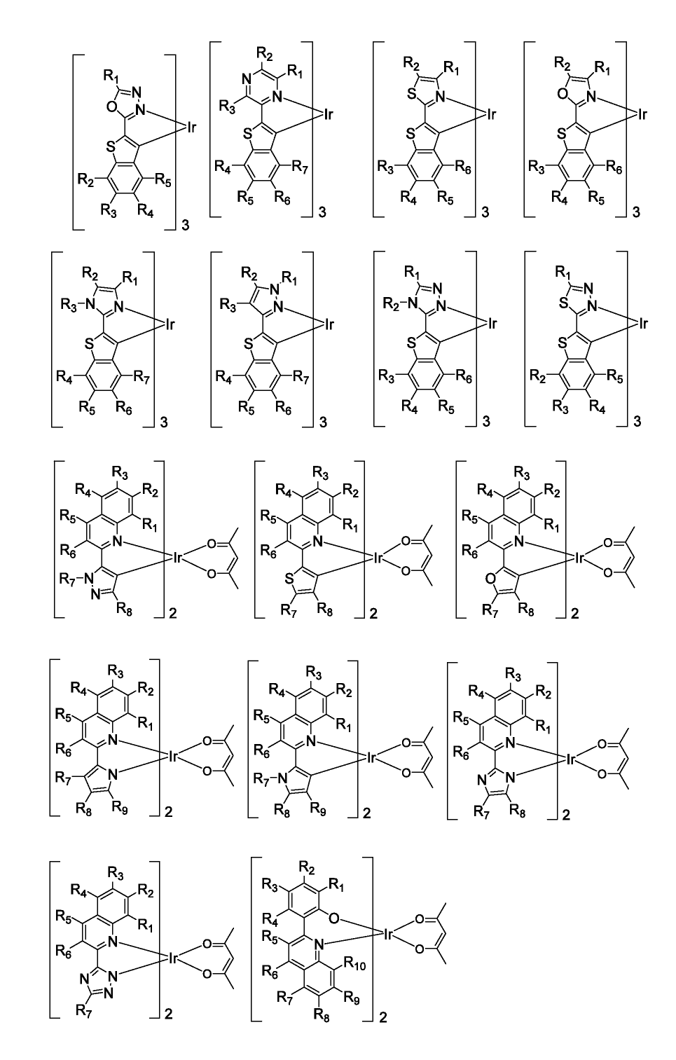

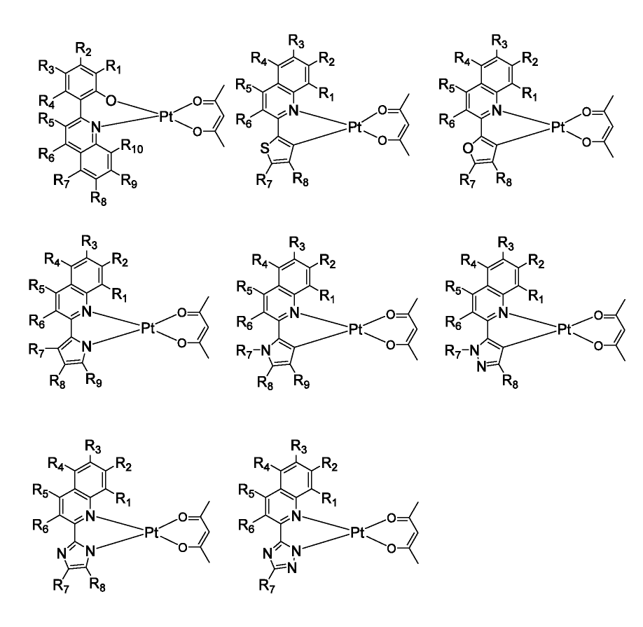

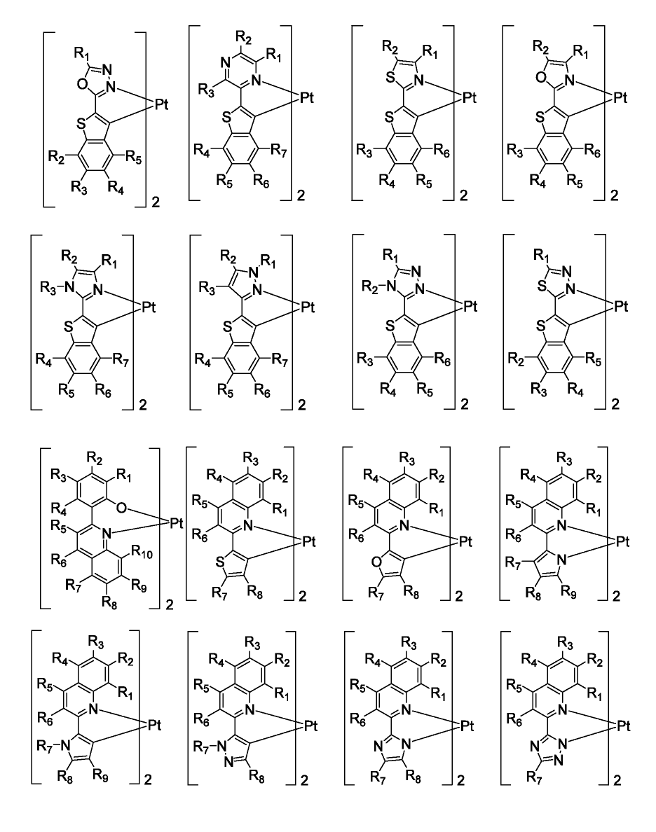

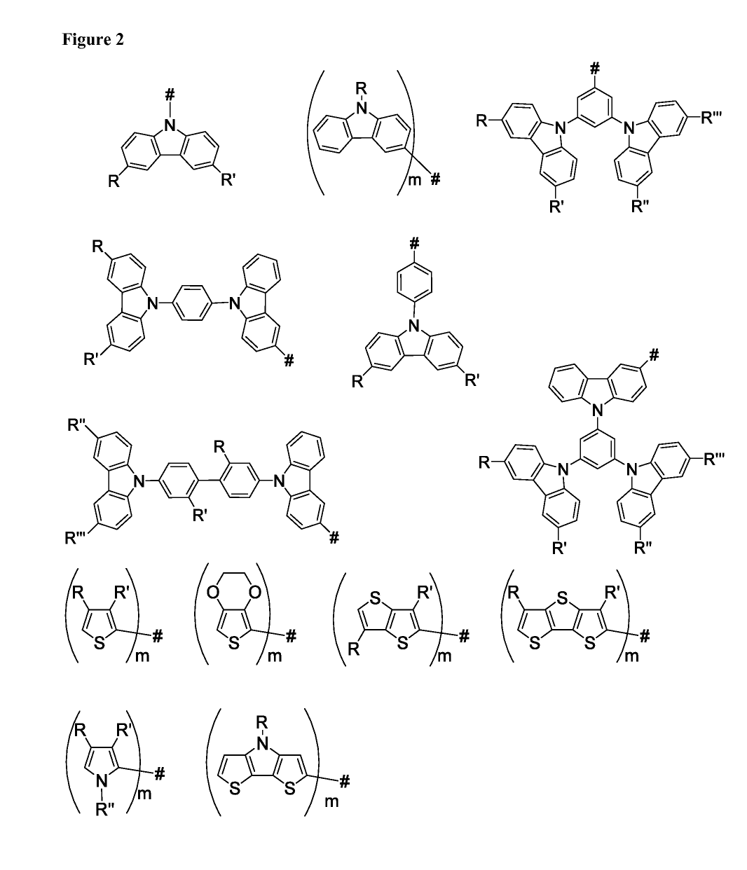

FIG. 2 shows examples of ctg in the form of hole transport groups as the substituents of a ligand lig. R, R′, R″ and R′″ represent solubilizing groups, electron donating or withdrawing groups, and # represents the binding point to the ligand lig.

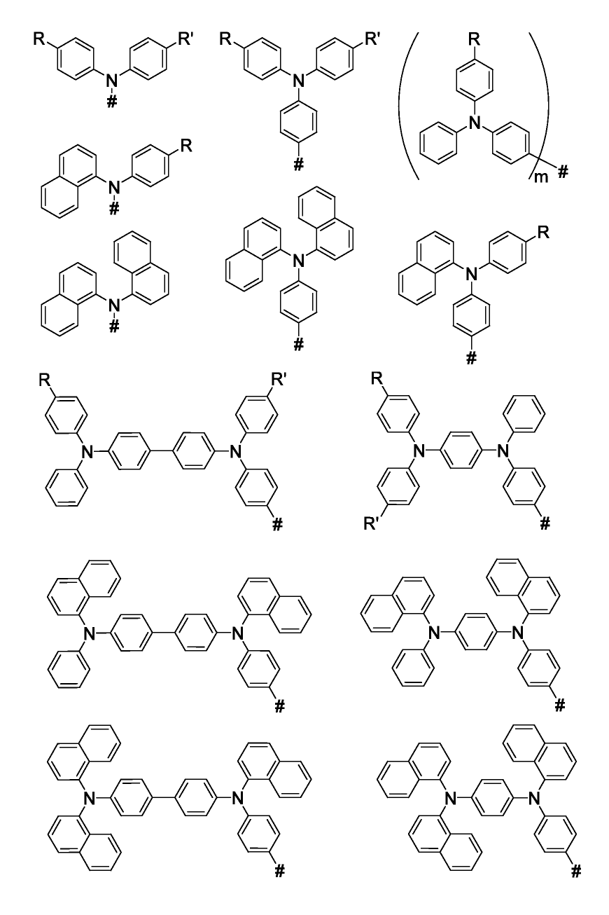

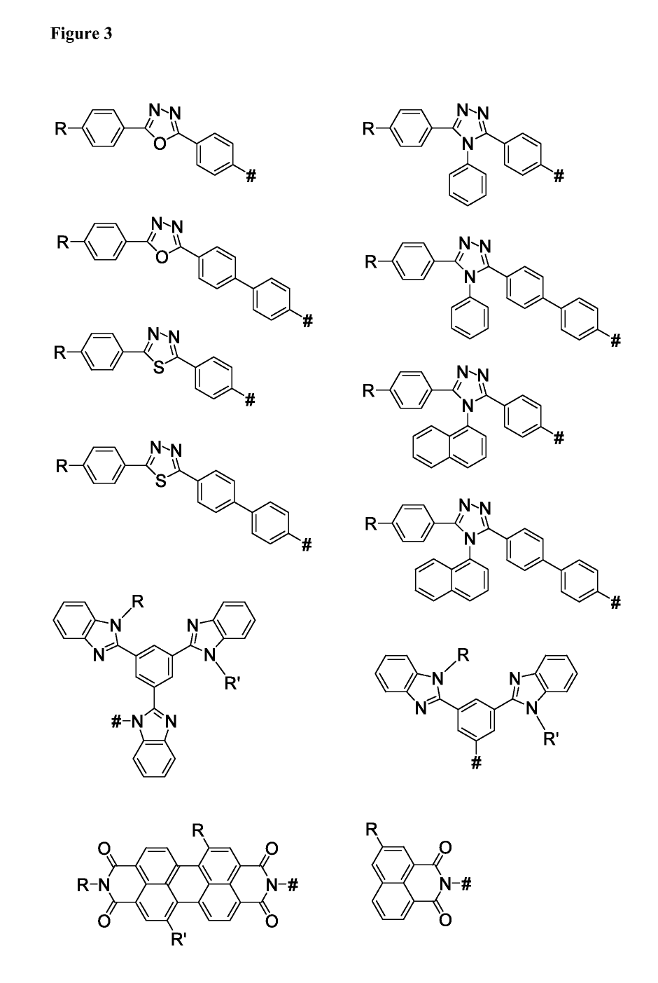

FIG. 3 shows examples of electron transport materials as the substituents of a ligand lig. R and R′ represent solubilizing groups, electron donating or withdrawing groups, and # represents the binding point to the ligand.

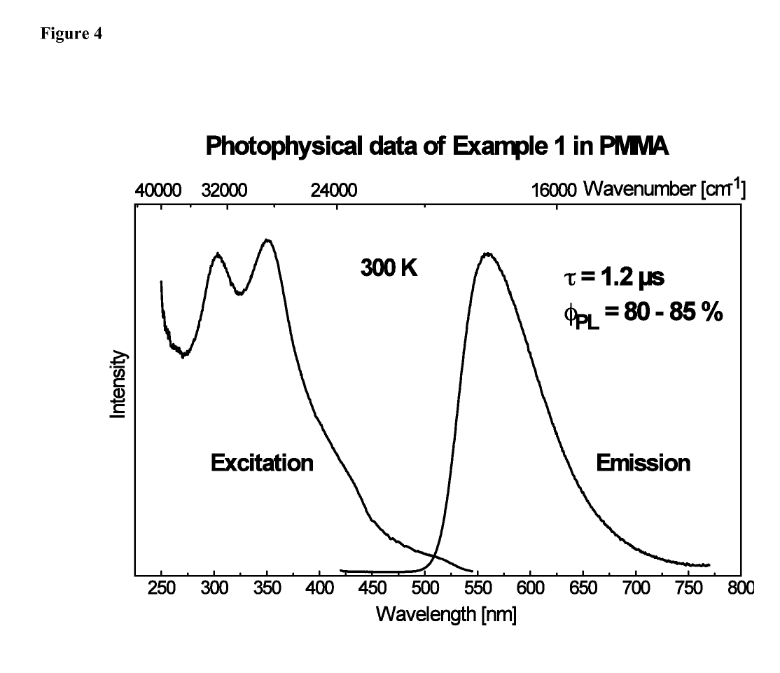

FIG. 4 shows emission and excitation spectra of Ir[(TPA)₂ ppy)]₃ that was dissolved in PMMA via CH₂Cl₂. The emission decay time was measured at λₘₐₓ=560 nm after excitation at λ_{exc}=372 nm.

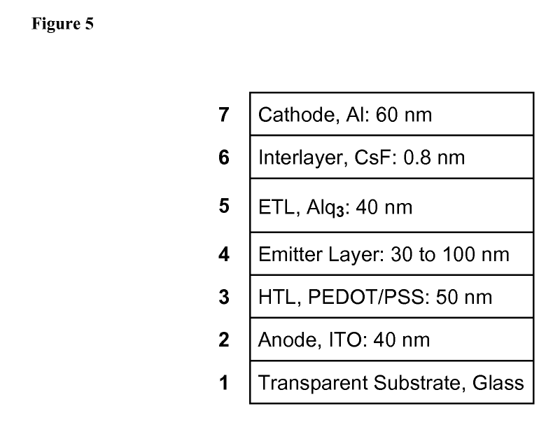

FIG. 5 shows an example of a simple device structure for an OLED. The layers 2-7 with a total thickness of about 300 nm can be applied onto a glass substrate 1 or onto another solid or flexible support. The layers 1 to 7 are as follows:
1. As a solid support, glass can be used or any other suitable solid or flexible transparent material.
2. ITO=Indium-tin-oxide
3. PEDOT/PSS=Poly(3,4-ethylenedioxythiophene):Poly(styrenesulfonate), example of a material for transporting holes (HTL=hole transport layer), which is water soluble.
4. Emitter-Layer (EML) comprising a complex of the invention as an emitter. The complex of the invention can be solubilized, e.g. in an organic solvent and be applied together with a matrix material (e.g. PVK=polyvinylcarbazole or CBP=4,4′-bis(9-carbazolyl)biphenyl). By choosing an appropriate organic solvent, the dissolution of the lower PEDOT/PSS layer can be prevented. Preferably, a complex of the invention is present in this layer in 5%-by-weight to 10-15%-by-weight. The complex of the invention can also be doped in an inert polymer, e.g. poly(methyl methacrylate) (PMMA) or polystyrene (PS).
5. ETL=electron transport layer. Alq₃ can e.g. be used, which can be deposited using sublimation techniques (thickness e.g. 40 nm).
6. Layer for protection and reduction of the injection barrier, which is usually deposited using sublimation techniques. This thin intermediate layer made up of e.g. CsF or LiF lowers the barrier for electron injection and protects the ETL layer. In a simplified OLED, the ETL and the CsF layer may be omitted.
7. The conducting cathode layer is deposited by sublimation. Al may be used, but also Mg:Ag (10:1) or other metals.

The voltage applied at the device is e.g. 3 V to 15 V.

### EXAMPLES

The homoleptic fac-iridium complexes were synthesized by refluxing Ir(acac)₃ and cyclometallated ligands in glycerol. The coordination geometry of the ligands on the Ir(III) metal center has been confirmed to be facial by X-ray crystallography.

The present invention will be described in more detail with reference to the accompanying synthesis, characterization and photophysical properties of one of the representative complex of this invention:

### Example 1

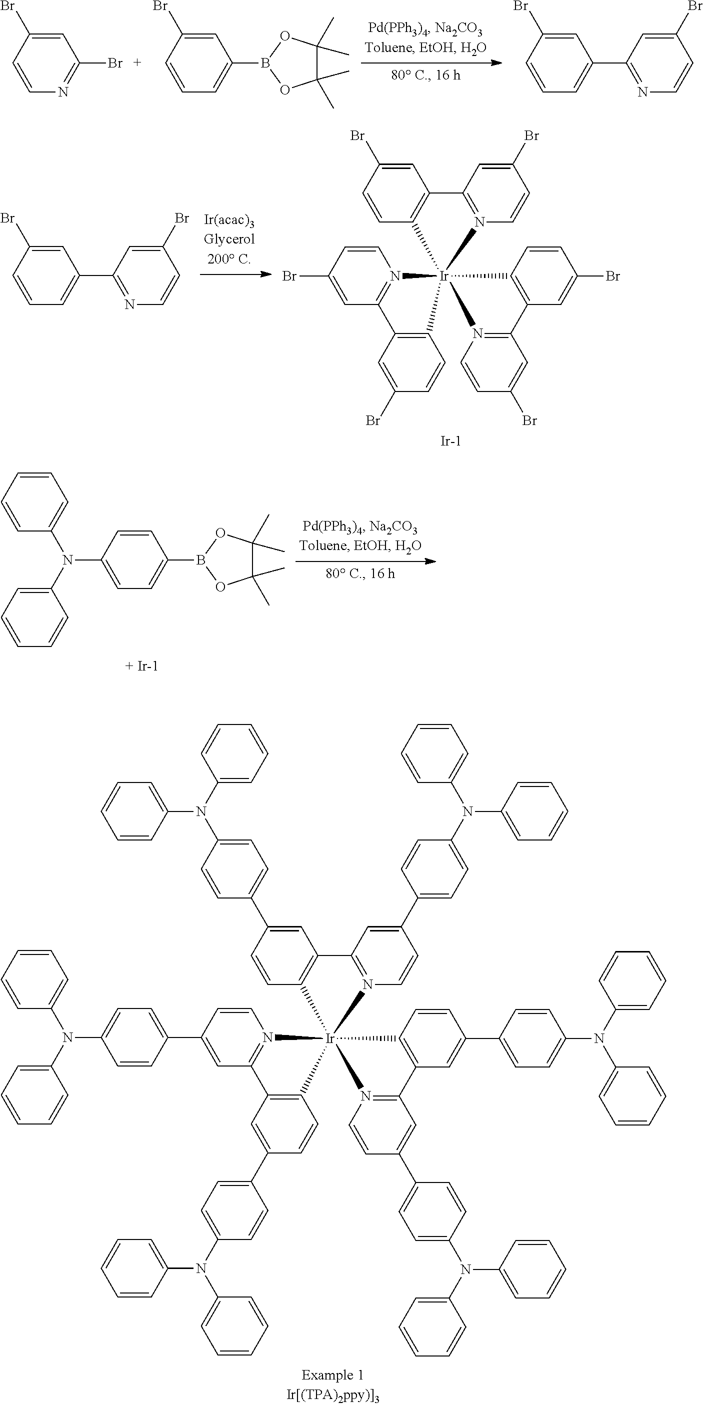

Bromide functionalized phenylpyridine was synthesized and underwent complexation with Ir(acac)₃ at 200° C. to ensure that the fac-isomer was obtained. The substituted emitter was synthesized by a straightforward coupling of the fac-Ir(III) complex to triarylamine-boronates using a Suzuki coupling.

### Synthesis of Example 1

μ-dichlorotetrakis(2-(3-bromophenyl-3-bromopyridinato-κN,C)diiridium (97 mg, 0.086 mmol) and diphenyl-[4-(4,4,5,5,-tetramethyl-[1,3,2]dioxaboralane-2-yl)amine (239 mg, 0.65 mmol) and sodium carbonate (137 mg, 1.29 mmol) were added distilled toluene (50 mL), absolute ethanol (20 mL) and distilled water (15 mL). The white suspension was degassed for half an hour before tetrakis(triphenylphosphine)palladium (30 mg, 0.026 mmol) was added. The yellow biphasic mixture was heated to 80° C. and stirred under N₂ overnight. The mixture was cooled down to room temperature. The organic phase was separated and the aqueous phase was extracted with DCM (3×50 mL). The combined organic extracts were dried over MgSO₄ and the solvent was removed under vacuum to yield a red oil. The crude product was then purified by silica column chromatography with DCM/Hexane (1:2) as eluent and afforded a yellow solid (30 mg, 16.5%).

¹H NMR (300 MHz, CDCl₃): δ 6.91-7.02 (m, 9H, ArH), 7.05-7.32 (m, 75H, ArH), 7.50-7.56 (m, 9H, ArH), 7.68 (d, 3H, ArH, J=5.9 Hz), 7.95 (bs, 3H, ArH), 8.14 (bs, 3H, ArH).

Emission and excitation spectra of Ir[(TPA)₂ ppy)]₃ dissolved in PMMA (via CH₂Cl₂) is shown in FIG. 4. The emission decay time was measured at λₘₐₓ=560 nm after excitation at λ_{exc}372 nm.

The complex of example 1, Ir[(TPA)₂ ppy)]₃, is a complex in which all three ligands lig and all ctgs are identical. A person of skill in the art will be aware of how to synthesize complexes with different ligands and/or ctgs.

1. A complex of formula I capable of luminescence 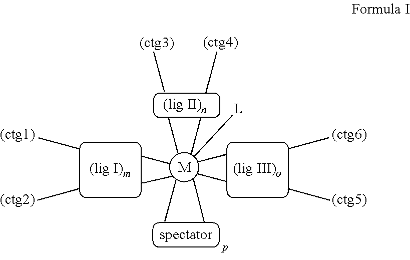
wherein:
M is a metal ion;
lig is a ligand with a conjugated π-electronic system and is bound to the metal ion M and comprises at least two aromatic rings;
ctg is an organic charge transporting group for transporting holes or electrons and for improving the solubility of the complex in an organic solvent,
n, m, o, p is each an integer that is 0, 1, 2, or 4, wherein the sum of n, m, o, p is
2 for a metal ion M with 4 coordination sites,
3 for a metal ion M with 6 coordination sites, and
4 for a metal ion M with 8 or 9 coordination sites;
ligI(ctg1)(ctg2), ligII(ctg3)(ctg4), and ligIII(ctg5)(ctg6) can be are the same or different;
L is an optional neutral mono-dentate ligand, which is present when the metal ion M is a lanthanide metal ion with 9 coordination sites, and
spectator is a bidentate negatively charged ligand.

2-23. (canceled)

24. The complex of claim 1, wherein the luminescence is phosphorescence or electroluminescence.

25. The complex of claim 1, wherein the ctg for transporting a hole comprises a chemical group selected from the group consisting of:
substituted or unsubstituted diarylamine, substituted or unsubstituted triarylamine, substituted or unsubstituted carbazole, substituted or unsubstituted thiophene, substituted or unsubstituted pyrrole, substituted or unsubstituted 3,4-ethylenedioxythiophene, substituted or unsubstituted fused thienothiophene, substituted or unsubstituted oligothiophene, substituted or unsubstituted tris(oligoarylenyl)amine, substituted or unsubstituted spiro compound, and substituted or unsubstituted benzidine compound.

26. The complex of claim 1, wherein the ctg for transporting an electron comprises a chemical group selected from the group consisting of:
substituted or unsubstituted oxadiazole, substituted or unsubstituted thiadiazole, substituted or unsubstituted triazole, substituted or unsubstituted pyridine, fluoroaryl, fluoroheteroaryl, substituted or unsubstituted benzimidazole, substituted or unsubstituted perylene and perylene derivatives, substituted or unsubstituted tris(phenylquinoxaline), substituted or unsubstituted silole compound, and substituted or unsubstituted boron containing compound.

27. The complex of claim 1, wherein the aryl or heteroaryl group of the ligand comprises a chemical group selected from the group consisting of:
phenyl, biphenyl, phenol, pyridine, pyrimidine, pyrazine, triazine, pyrrole, pyrazole, imidiazole, triazole, thiophene, furan, thiazole, oxazole, oxadiazole, thiadiazole, naphalene, phenanthrene, fluorine, carbazole, benzothiophene, benzimidazole, benzothiazole, and benzooxazole.

28. A complex of formula II capable of luminescence 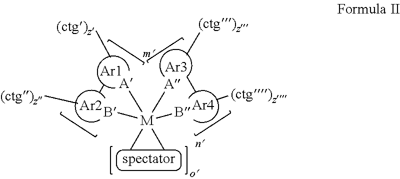
wherein:
M is a metal ion;
Ar1, Ar2, Ar3 and Ar4 are the same or different aromatic rings;
ctg′, ctg″,ctg′″, and ctg″″ are the same or different charge transporting groups being substituted covalently to Ar1, Ar2, Ar3 and Ar4, respectively;
A and B and A′ and B′ are the same or different and represent the coordination sites to the metal ion;
z′, z″, z′″, and z″″ are the same or different and represent an integer of 1 to 4;
n′, m′, o′ are each an integer that can independently be from 0 to 4, wherein the sum of n′, m′, o′ is 2 for a metal ion M with 4 coordination sites, 3 for a metal ion M with 6 coordination sites, 4 for a metal ion M with 8 coordination sites; and
the ligands formed by Ar1 and Ar2 or Ar3 and Ar4 chelating to the metal ion M are the same or different; and
spectator is a bidentate negatively charged ligand.

29. The complex of claim 1, comprising at least one ctg for transporting holes and at least one ctg for transporting electrons, thereby forming a bipolar complex capable of electron transport, hole transport, and light emission.

30. A method for emitting or absorbing light comprising the step of providing a complex of claim 1 or 28 as a light emitter or a light absorber.

31. The method of claim 30, wherein the complex is used at a concentration of 1 weight % to 30 weight % together with at least one other material.

32. The method of claim 30, wherein the complex is provided in an opto-electronic element.

33. A method for emitting light in a sensor element in a sensor comprising the step of providing a complex of claim 1 or 28 as a light emitter in the sensor element.

34. The method of claim 30 or 33, wherein a fraction of the complex in an emission layer is 100%.

35. The method of claim 30 or 33, wherein a fraction of the complex of the light emitter or the light absorber is 0.1% to 99%.

36. The method of claim 30 or 33, wherein a concentration of the complex as a light emitter in an optical light emitting element is between 1% and 20%.

37. The method of claim 30 or 33, wherein the complex serves both as a charge transport material and as a light emitting material.

38. An opto-electronic element comprising a complex of claim 1 or 28.

39. The complex of claim 1, wherein the metal ion is a heavy metal ion, a lanthanide ion or a d block element.

40. The complex of claim 1, wherein the at least two aromatic rings are covalently-linked to each other or fused together.

41. The complex of claim 1, wherein the ctg comprises an aryl or a heteroaryl.

42. The complex of claim 41, wherein the aryl or heteroaryl comprises a nitrogen, oxygen, sulfur and/or phosphorous atom.

43. The complex of claim 1, wherein L is an amine, imine, p-substituted pyridine, ether, isocyanate, isonitrile, nitrile, carbonyl, or a N-heterocycle.

44. The complex of claim 1, wherein the bidentate negatively charged ligand is selected from the group consisting of β-diketonate, nacnac, N-alkylsalicylimine, 2-picolinate, bidentate pyrazolyl-borate, 1,2-nido-carboranediphosphines, 1,2-nido-carboranediisocyanides, 1,2-nido-carboranediarsenates, singly negatively charged diamines, singly negatively charged diphosphines, singly negatively charged diarsines, singly negatively charged bis-guanidine, bidentate negatively charged thiolates, bidentate negatively charged alcoholates, and bidentate negatively charged phenolates.

45. The complex of claim 28, wherein the metal ion is a heavy metal ion, a lanthanide ion or a d block element.

46. The complex of claim 28, wherein Ar1 and Ar2 or Ar3 and Ar4 are covalently linked or fused together and represent a five or six-membered aryl, heteroaryl, fused aryl or a fused heteroaryl.

47. The complex of claim 28, wherein Ar1, Ar2, Ar3, or Ar4 comprises 2, 3, or 4 covalently linked or fused aromatic rings.

48. The complex of claim 28, wherein ligands are linked by a bridging group.

49. The complex of claim 48, wherein the bridging group is an aryl, substituted aryl, amine, ether, oligo-ether, vinyl, alkene group, aliphatic group, spiro group, silyl group, borane group, phosphane group, arsane group, or silane group.

50. The complex of claim 28, wherein ctg′, ctg″,ctg′″, or ctg″″ is a conjugated hole or an electron transporting group comprising an aryl or heteroaryl, wherein the aryl or heteroaryl comprises a nitrogen, oxygen, sulfur and/or phosphorous atom.

51. The complex of claim 28, wherein A, B, A′ or B′ is carbon or nitrogen.

52. The complex of claim 28, wherein the bidentate negatively charged ligand is selected from the group consisting of:
β-diketonate, nacnac, N-alkylsalicylimine, 2-picolinate, bidentate pyrazolyl-borate, 1,2-nido-carboranediphosphines, 1,2-nido-carboranediisocyanides, 1,2-nido-carboranediarsenates, singly negatively charged diamines, singly negatively charged diphosphines, singly negatively charged diarsines, singly negatively charged bis-guanidine, bidentate negatively charged thiolates, bidentate negatively charged alcoholates, and bidentate negatively charged phenolates

53. The method of claim 32, wherein the opto-electronic element is selected from the group consisting of:
organic light-emitting diodes (OLEDs),
light-emitting electrochemical cells,
OLED-sensors,
organic photodiodes,
organic diodes,
organic solar cells,
organic field effect transistors,
organic lasers,
down-conversion systems, and
lighting devices.
